(19) United States
(12) Patent Application Publication
(10) Pub. No.: US 2018/0141071 A1
(43) Pub. Date: May 24, 2018

(54) COATING APPARATUS HAVING EXTENSION MEANS

(71) Applicant: JOSEF SCHIELE OHG, Niederzissen (DE)

(72) Inventor: Stefan Schiele, Niederzissen (DE)

(21) Appl. No.: 15/573,663

(22) PCT Filed: May 24, 2016
(86) PCT No.: PCT/EP2016/061668

§ 371 Date: Nov. 13, 2017

(30) Foreign Application Priority Data
May 26, 2015 (DE) 10 2015 209 616.5

(51) Int. Cl. B05B 12/18; B05B 13/02; B05C 11/10; B05C 21/00; B05C 5/02

(52) U.S. Cl. CPC B05B 12/18; B05B 13/0221; B05C 5/0204; B05C 21/005; B05C 11/1039

(57) ABSTRACT

The present invention relates to a coating apparatus comprising a conveying device that conveys a workpiece and/or a flat profile along a coating head in a direction of conveyance, said coating head providing the edge of the workpiece and/or the flat profile with a coating.

The present invention relates to a coating apparatus having a transporting device, which transports a workpiece and/or a sheet-like profile in a transporting direction along a coating head, which provides the edge of the workpiece and/or the sheet-like profile with a coating.

Such coating apparatuses are known from the prior art. In the case of these coating apparatuses, a workpiece is transported in relation to a coating head, which provides an edge of the workpiece with a coating, for example a coating of paint, in particular a water-based paint. The coating may however also be a radiation-curing paint. In the case of the coating heads of the present applicant, the coating head is additionally subjected to a negative pressure in comparison with ambient pressure, by which a stream of air by which the layer thickness of the coating is regulated and excessively applied coating material is removed again is sucked into the coating head. The coating apparatuses from the prior art have the disadvantage however that there can be places at the corners of the workpieces where there is a build-up of paint or no paint.

The object of the present invention was therefore to provide a coating apparatus that does not have the disadvantages of the prior art.

The object is achieved by a coating apparatus having a transporting device that transports a workpiece and/or a preferably sheet-like profile in a transporting direction along a coating head, which provides the edge of a workpiece and/or the profile with a coating, the coating apparatus having at least one extension means, which reversibly extends the edge and/or the profile to be coated in and/or counter to the transporting direction.

The statements made in relation to this subject matter of the present invention equally apply to the method according to the invention, and vice versa.

The present invention relates to a coating apparatus which for example applies a paint, in particular a water-based paint and/or a radiation-curing paint, to part of the peripheral edge of a workpiece and/or to a sheet-like profile. The workpiece/profile may be produced from wood, metal, plastic or a combination of these materials. The workpiece/profile may for example be of a rectangular or square shape. In particular, the workpiece is preferably provided in a sheet-like form, i.e. one dimension is much smaller than the other two. It is always the case that at least part of the peripheral edge of the workpiece, generally one side of the peripheral edge, is coated. The profile may be for example part of a frame of a window or a door or a kitchen front. In any event, it is important that the coating is provided uniformly, in particular that there are no beads of paint or places with no paint.

The coating apparatus has according to the invention a coating head or an application chamber, by which the coat of paint is applied, there being a relative movement between the application head and the workpiece/profile during the coating. Preferably, the coating head or the application chamber is fixed in place and the workpiece/profile moves in a transporting direction, in particular a linear transporting direction, in relation to the coating head, it being possible for the movement of the workpiece/profile during the coating to be continuous or discontinuous. While the workpiece is being transported, the coating is applied to the edge of the workpiece. In the case of the profile, generally one side is partially or completely coated. It is also preferred that the layer thickness with which the paint is applied to the workpiece/profile is regulated by a stream of air, which removes excess paint from the workpiece/profile again and/or distributes it uniformly on the workpiece/profile. This stream of air is preferably produced by a negative pressure being applied to the coating head or the application chamber, by which air that strips off excess paint from the workpiece/profile is sucked through a gap between the workpiece/profile and the coating head or the application chamber.

Preferably, this stream of air is fed downstream of the coating head or the application chamber to a separating system, which at least partially, preferably almost completely, removes the paint constituents from the stream of air.

After the coating, the coating agent is dried. This may be performed for example by supplying heat and/or radiation, for example by means of an IR or UV emitter.

According to the invention, the coating apparatus has at least one extension means, which reversibly extends the edge or the profile to be coated in and/or counter to the transporting direction.

Before and/or when the workpiece/profile enters, the extension means is brought into contact with it and passes the coating head together with it. The extension means extends the edge or the profile to be coated in the transporting direction of the workpiece/profile through the coating head. With respect to the transporting direction of the workpiece, an extension means can accordingly be provided upstream and/or downstream of the edge or the profile to be coated.

Preferably, the extension means extends the edge or the profile to be coated in the same form, i.e. it preferably has at least in the contact region with the workpiece/profile the same width and/or the same contour as the edge or the profile to be coated. If for example the part of the peripheral edge or the profile to be coated is convex, the part of the extension means that adjoins the edge to be coated is likewise convex and has at least approximately the same curvature as the edge or the profile to be coated. The same applies analogously for example to an edge or a profile with a concave or a straight form. Preferably, there is a smallest possible gap, in particular no gap, between the extension and the workpiece/profile.

Preferably, each extension means is provided exchangeably on the coating apparatus, so that, when there is a change of the form of the workpieces/profiles to be coated and/or when there is a change of the form of the edge or the profile to be coated, it can likewise be exchanged.

Preferably, at least for a time, in particular during the coating operation, the extension means moves at the same speed and in the same direction as the workpiece/profile. Preferably, before contact with the workpiece/profile, the extension means is accelerated or decelerated in such a way that it comes into contact with the workpiece/profile, in particular the moving workpiece/profile. As soon as there is contact between the extension means and the workpiece/profile, it is moved, in particular during the coating, preferably at the same speed and particularly preferably in the same direction as the workpiece/profile. Once the extended corner of the workpiece/profile and/or the extension means has left the coating head, it is accelerated or decelerated again in relation to the workpiece/profile and/or changes its direction of movement in such a way that the contact between the extension means and the workpiece/profile is broken again.

Preferably, the extension means lies flush against the edge or the profile, at least in the corner region of the edge or the profile to be coated. Preferably, the extension means tapers from the contact region between the workpiece/profile and the extension means in or counter to the transporting direction of the workpiece, i.e. the distance between the adjoining edge of the extension with respect to the workpiece/profile and the coating head increases as the distance from the respective corner region of the edge to be coated or the coating surface of the profile increases, parallel to the direction of movement of the workpiece/profile.

According to a preferred embodiment of the present invention, the extension means consists of a material and/or is provided with a coating on which the coating agent adheres to a reduced extent in comparison with the workpiece/profile. This allows the coating, which is inevitably also applied to parts of the extension means, to be removed again more easily.

As an alternative or in addition, in particular in the case of a water-soluble coating agent, the extension means may be cooled, in particular to or below the dew point of the surrounding air. As a result, the coating agent does not dry on the extension means and can be removed comparatively easily.

Preferably, the coating apparatus has a cleaning device for the extension means, which removes coating agent from the extension means.

Preferably, each extension means is moved in a circulating manner, i.e. after coating a workpiece/profile it is brought again into a starting position and from there is in turn brought to lie against a new workpiece/profile. During this circulation, the cleaning of the extension means is preferably then also performed. Preferably, the coating apparatus has a number of extension means that are moved in a circulating manner. The drive of the extension means may be provided by any drive familiar to a person skilled in the art.

A further subject matter of the present invention is a method for coating the edge of a workpiece or a profile, which is transported in a transporting direction past a coating head and the edge or one side of the profile is thereby coated by the coating head, in which before the coating the edge or the profile to be coated is reversibly extended in and/or counter to the transporting direction.

The statements made in relation to this subject matter of the present invention equally apply to the apparatus according to the invention, and vice versa.

In the method according to the invention, the edge to be coated or the side of the profile to be coated is reversibly extended. As a result, in particular in the region at the start and the region at the end with respect to the transporting direction of the workpiece/profile, there are no places where there is a build-up of paint or no paint. After the coating, the extension is removed again from the workpiece or the profile.

In order to come into contact with the workpiece or the profile, the extension means is moved. Preferably, the extension means is accelerated in order to come into contact with the workpiece. Preferably, the workpiece moves during the approach of the extension means. After contact between the extension means and the workpiece/profile, they move at the same speed and in the same direction until the contact is broken again.

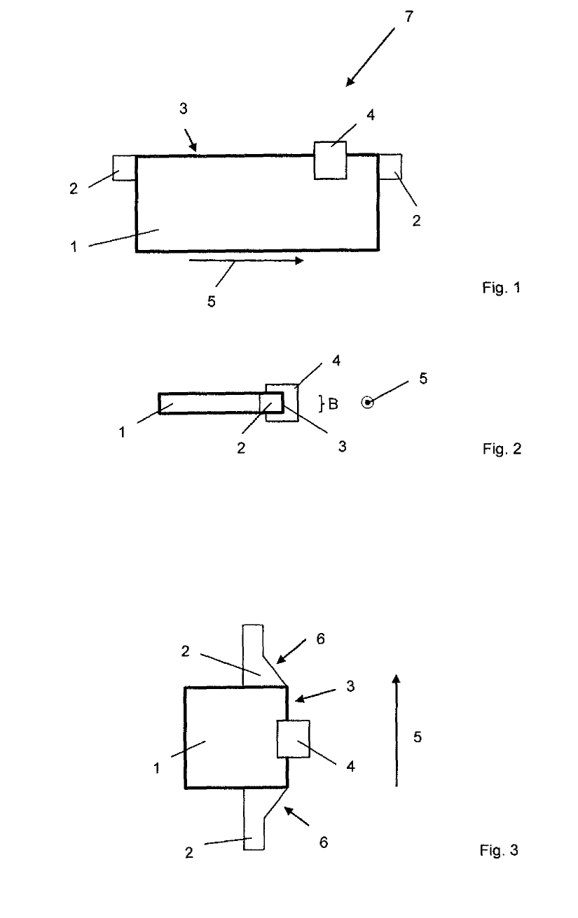

The inventions are explained below on the basis of FIGS. 1-3. These explanations are merely given by way of example and do not restrict the general concept of the invention.

FIGS. 1 and 2 show two views of the coating apparatus according to the invention.

FIG. 3 shows an extension means with a taper.

FIG. 1 shows the coating apparatus 7 according to the invention, which has a coating head 4, with which a coating agent, for example a paint, in particular a water-based paint, is applied to an edge 3 of a workpiece 1. For this purpose, the workpiece 1 moves in the direction indicated by the arrow 5, here from left to right. The coating head has at least one nozzle, with which the coating agent is applied to the edge to be coated. Preferably, the coating head 4 additionally has a means by which a stream of air from the surroundings can be produced through a gap between the workpiece and the coating head into the coating head. The means is preferably a negative pressure in relation to the ambient pressure. With the stream of air, excessively applied coating agent is removed again from the workpiece, or the coating is made more uniform. According to the invention, the coating apparatus thus has at least one extension means 2, here two extension means 2, which in each case directly adjoin the edge to be coated and virtually extend it, and which are transported together with the workpiece through the coating head. Each extension means is brought into contact with the workpiece before the coating in such a manner that there is preferably, if at all, only a very small gap between the workpiece and the extension means. For this purpose, each extension means 2 is accelerated or decelerated in relation to the workpiece 1. During the coating in particular of the region of the edge that adjoins the extension means, the extension means 2 and the workpiece 1 have the same speed, or the same direction of movement. Once the edge 3 has been coated, the extension means 2 is removed again from the workpiece 1 and the coating can be dried thereby or thereafter.

As can be seen in particular from FIG. 2, the extension means 2 are preferably provided in the same form as the edge to be coated, that is to say that they have for example the same width B as the workpiece. For the case where the edge to be coated has a curvature, the extension means preferably has the same curvature, at least in the directly adjoining region with respect to the workpiece. For the case where the edge to be coated is straight, the adjoining edge of the extension means is likewise straight. Shown in turn in FIG. 2 is the direction of movement 5 of the workpiece, which in the present case is directed out of the plane of the paper.

FIG. 3 shows a further embodiment of the apparatus according to the invention. In the present case, the extension means 2 have a taper 6. It is evident that, in and counter to the transporting direction, the adjoining edge of the extension means recedes from the workpiece. As a result, a particularly uniform coating of paint without any places where there is no paint or a build-up of paint is achieved.

A person skilled in the art understands that the description of the figures also applies analogously to a profile, in the case of which generally one side of the profile is coated.

### LIST OF DESIGNATIONS

1 Workpiece, profile
2 Extension means
3 Edge to be coated
4 Coating head, application chamber
5 Transporting direction of the workpiece
6 Taper
7 Coating apparatus
B Width of the workpiece or the extension means in the contact region

1. A coating apparatus having a transporting device, which transports a workpiece and/or a sheet-like profile in a transporting direction along a coating head, which provides an edge of the workpiece and/or the profile with a coating, the coating head having a means by which a stream of air from the surroundings produced through a gap between the workpiece and the coating head into the coating head, the coating apparatus having at least one extension means, which reversibly extends the edge or the profile to be coated in and/or counter to the transporting direction, wherein the extension means comprises a material and/or is provided with a coating on which the coating agent adheres to a reduced extent in comparison with the workpiece/profile, and/or in that the extension means is cooled.

2. The coating apparatus as claimed in claim 1, wherein the extension means extends the edge and/or the profile in the same form.

3. The coating apparatus as claimed in claim 1, wherein the extension means lies flush against the edge and/or against the profile.

4. The coating apparatus as claimed in claim 1, wherein the coating apparatus has a cleaning device for the extension means.

5. A method for coating an edge of a workpiece and/or a profile, which in each case is transported in a transporting direction past a coating head of a coating apparatus as claimed in claim 1 and the edge of the workpiece and/or one side of the sheet-like profile is thereby coated by the coating head, wherein before the coating the edge and/or the profile to be coated is reversibly extended in and/or counter to the transporting direction by the extension means.

6. The method as claimed in claim 5, wherein the extension means is accelerated in order to come into contact with the workpiece/profile.

7. The method as claimed in claim 5, wherein, at least for a time, extension means moves at the same speed as the workpiece/profile.

8. The method as claimed in claim 5, wherein the extension means is moved in a circulating manner.

9. The method as claimed in claim 5, wherein the coating apparatus has on each side of the workpiece two or more extension means, which are used alternately.

10. The method as claimed in claim 9, wherein the extension means are operated and/or controlled in a cyclical manner.

11. The coating apparatus of claim 1, wherein the means by which the stream of air from the surroundings is produced is a negative pressure.

12. The coating apparatus of claim 1, wherein the extension means is cooled to or below the dew point of the ambient air.

13. The method as claimed in claim 7, wherein during the coating operation the extension means moves at the same speed as the workpiece/profile.
